(19) United States
(12) Patent Application Publication
(10) Pub. No.: US 2024/0278078 A1
(43) Pub. Date: Aug. 22, 2024

(54) SHAPE MEMORY POLYMERS USED IN GOLF BALLS

(71) Applicant: Acushnet Company, Fairhaven, MA (US)

(72) Inventors: Manjari Kuntimaddi, Raynham, MA (US); Erin C. McDermott, Providence, RI (US)

(73) Assignee: Acushnet Company, Fairhaven, MA (US)

(21) Appl. No.: 18/425,667

(22) Filed: Jan. 29, 2024

Related U.S. Application Data
(60) Provisional application No. 63/441,901, filed on Jan. 30, 2023.

(51) Int. Cl. A63B 37/00; C08G 18/32; C08G 18/73

(52) U.S. Cl. CPC A63B 37/0024; A63B 37/0058; A63B 37/0059; C08G 18/3206; C08G 18/3212; C08G 18/73; A63B 37/0074; A63B 37/0075; A63B 37/0076; A63B 2209/14

(57) ABSTRACT

Golf balls having a core, intermediate layer, and shape memory polymer cover are provided. The ball includes a non-foamed inner core (center) made of a thermoplastic or thermoset composition such as polybutadiene rubber. A cover having at least one layer is disposed about the core and intermediate layer. An SMP is used in the outermost layer of a golf ball. SMPs may be used in any layers of the golf ball to achieve reversible deformability.

### CROSS REFERENCE TO RELATED APPLICATIONS

The present application claims priority to Provisional Application No. 63/441,901, filed Jan. 30, 2023, the entire disclosure of which is hereby incorporated herein by reference.

### TECHNICAL FIELD

The present disclosure relates generally to the field of golf balls, and more specifically to shape memory polymers used in golf balls.

### BACKGROUND

The background description provided herein is for the purpose of generally presenting the context of the disclosure. The work of the presently named inventors, to the extent it is described in this background section, as well as aspects of the description that may not otherwise qualify as prior art at the time of filing, are neither expressly nor impliedly admitted as prior art against the present disclosure.

Conventional golf balls have two main functional components: the core and the cover. The main purpose of the core is to be the “spring” of the ball or the principal source of resiliency. The core may be solid or wound. The main purpose of the cover is to protect the core. Multi-layer solid balls include multi-layer core constructions or multi-layer cover constructions, and combinations thereof. In a golf ball with a multi-layer core, the principal source of resiliency is the multi-layer core. In a golf ball with a multi-layer cover, the principal source of resiliency is the single-layer core.

Two-layer solid balls are made with a single-solid core, typically a cross-linked polybutadiene or other rubber, encased by a hard cover material. Increasing the cross-link density of the core material may increase the resiliency of the core. As the resiliency increases, however, the compression may also increase making the ball stiffer, thereby making the golf ball less resilient to deformation. In an effort to make golf balls with improved performance characteristics, manufacturers have used thermoplastics in various layers in multi-layer golf balls. Some thermoplastic materials have a low flexural modulus, such that layers formed therefrom produce golf balls with undesirable levels of stiffness. Such high stiffness may also cause golf balls to become deformed more quickly over time by usage alone. Thus, manufacturers often try to optimize thermoplastic layers so that the golf balls produced have better stiffness. However, a need still exists for a golf ball with an outer layer material that may be deformed but returns to its original shape.

Shape memory polymers (“SMPs”) are a class of smart materials which are able to “memorize” a permanent shape.

SMPs may be fixed to temporary shapes under appropriate conditions, and also recover to permanent shapes in response to external triggers, e.g. heat, light, moisture, or magnetism.

Compared with their alloy counterparts, shape memory alloys, SMPs exhibit many advantages, including low density, extremely high recoverable strain, broad shape recovery temperature range, and a variety of different stimulating methods.

This “intelligent” material technology has given rise to many interesting developments in both industry as well as academia, and now it has been applied in many fields, such as shrinkable tubes, smart fabrics, solar sails of spacecraft, and surgery implants.

In general, SMPs possess a dual segment/domain structure where one “hard” segment/domain is always elastic to maintain permanent shape and the other “soft” one is transitionable in the presence of an appropriate stimulus.

Up until recently, various polymer systems have been exploited for shape memory behavior, including polyethylenes, polystyrenes, polyurethanes, and polyacrylates. Among them, polyurethanes receive distinct attention for facile preparation, good biocompatibility, and especially tunable properties. Polyurethanes are normally made of tangled long linear chains consisting of two types of alternatively connected segments where the structural units derived from diisocyanate and chain extenders constitute the hard segments whereas those from diisocyanate and macroglycols convert to the soft segments. By introducing functional units, the soft segments are well designed and versatile performances of SMPs will be obtained.

Jing et al. (2005) used poly(3-caprolactone) as soft segments of polyurethanes, and lowest recovery temperature of SMPs was controlled in the range of 37-42° C., and reasonable rigidity could be retained after shape recovery, fulfilling the essential requirements of medical implantations. Ping P., Wang W., Chen X., Jing X., Biomacromolecules. 2005; 6:587-592.

Hu et al., (2009) found polyurethanes containing pyridine moieties had excellent moisture absorption properties, which was based on the dissociation or disrupt of hydrogen bonding in the pyridine-ring induced by moisture absorption. Chen S., Hu J., Yuen C., Chan L., Polymer. 2009; 50:4424-4428.

Luo et al., (2013) found introduction of zwitterionic units into polyurethanes significantly improved hydrophilicity and reduced protein adsorption. Cao J. Yang M. Lu A. Zhai S. Chen Y. Luo X. J. Biomed. Mater. Res., Part A. 2013; 101A: 909-918.

Later, Chen et al. (2016) demonstrated zwitterionic polyurethanes had multi-shape memory effects, moisture-sensitive shape memory effect, and self-healing properties. Chen S., Mei Z., Ren H., Zhuo H., Liu J., Ge Z., Polym. Chem. 2016; 7:5773-5782.

Shape memory polymers are widely known in the art, and are discussed, for example, in U.S. Pat. No. 7,484,735, entitled “Reversible Thermally Expandable and/or Contractible Seal Assemblies”, and issued on Feb. 3, 2009, the disclosure of which is hereby incorporated in its entirety.

These works greatly promoted the development of polyurethane-based SMPs. But SMP technology, much less polyurethane-based SMPs, has not been applied in golf balls. SMP technology would greatly enhance the field of golf equipment, and golf balls specifically by providing a unique mechanism for a golf ball to retain its original shape.

This invention provides the opportunity for an object, in particular a golf ball, to rebound to its initial shape after being struck. This provides a unique material that may be hit repeatedly and maintain its original properties.

### SUMMARY

The following presents a simplified summary of the present disclosure in order to provide a basic understanding of some aspects of the disclosure. This summary is not an extensive overview of the disclosure. It is not intended to identify key or critical elements of the disclosure or to delineate the scope of the disclosure. The following summary merely presents some concepts of the disclosure in a simplified form as a prelude to the more detailed description provided below.

In one embodiment, the disclosure describes a golf ball including one or more layers including one or more shape memory polymers (SMPs), wherein at least one of the one or more layers is an outer layer, and wherein the one or more SMPs includes at least one of: a polyurethane; a polysulfone; a polyester; a polyamide; or a polyimide.

In an embodiment, the disclosure describes the SMP as the outermost layer of a golf ball.

In another embodiment, the disclosure describes the SMP as cast in a golf ball.

In another embodiment, the disclosure describes the SMP as injection molded in a golf ball.

In another embodiment, the disclosure describes the SMP as a shape memory polyurethane.

In another embodiment, the disclosure describes the SMP as used in a core formulation individually.

In another embodiment, the disclosure describes the SMP as used in a core formulation in combination with rubber.

In another embodiment, the disclosure describes the SMP as used in a core formulation in combination with a high acid ionomer.

Golf equipment, such as balls, gloves, shoes, and clubs, may be equipped with a soft foam of SMPs, such that when deformed with pressure, the material recovers its original properties.

This invention has not been used yet in sports equipment, much less golf equipment.

This invention includes all varieties of SMPs, including composites and other additivities, including functionalized graphite or graphene.

### BRIEF DESCRIPTION OF THE DRAWINGS

Non-limiting and non-exhaustive embodiments are described in reference to the following drawings. The components in the figures are not necessarily to scale, emphasis instead being placed upon illustrating the principles of the disclosure. In the drawings, like reference numerals refer to like parts through all the various figures unless otherwise specified.

For a better understanding of the present disclosure, a reference will be made to the following detailed description, which is to be read in association with the accompanying drawings, wherein:

FIG. 1 is a cross-sectional view of a two-piece golf ball in accordance with an embodiment of the present disclosure;

FIG. 2 is a cross-sectional view of a three-piece golf ball in accordance with an embodiment of the present disclosure;

FIG. 3 is a cross-sectional view of a four-piece golf ball in accordance with an embodiment of the present disclosure; and

FIG. 4 is a cross-sectional view of a five-piece golf ball in accordance with an embodiment of the present disclosure.

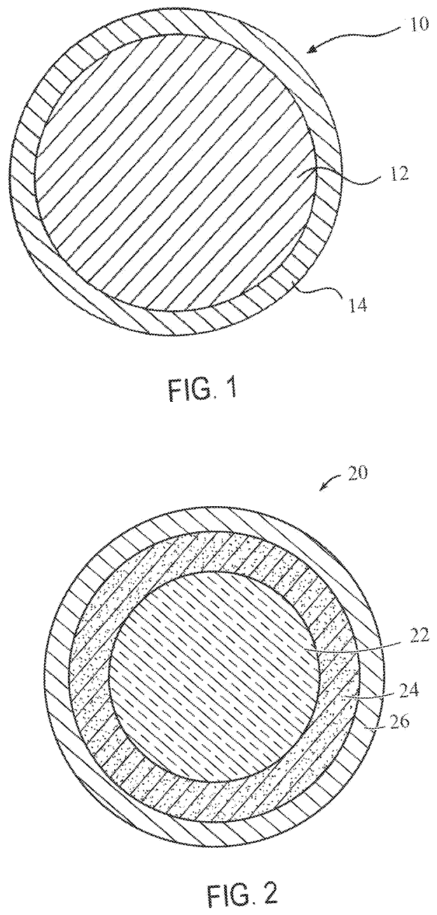

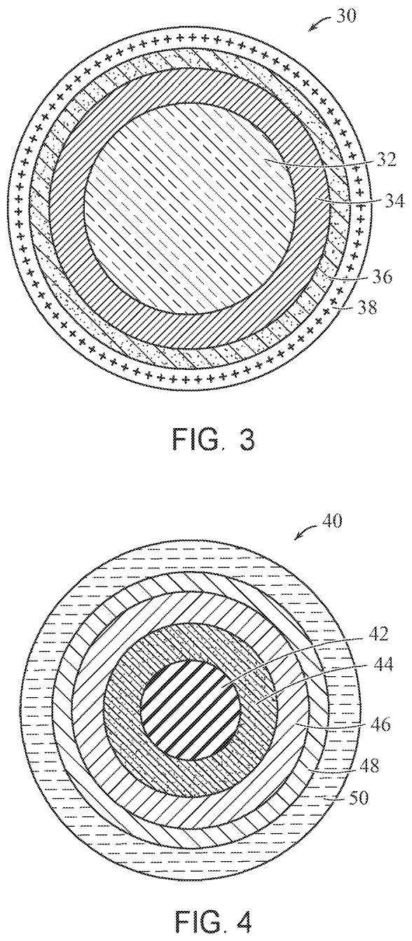

Persons of ordinary skill in the art will appreciate that elements in the figures are illustrated for simplicity and clarity so not all connections and options have been shown to avoid obscuring the inventive aspects. For example, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein are to be defined with respect to their corresponding respective areas of inquiry and study except where specific meaning have otherwise been set forth herein.

### DETAILED DESCRIPTION

The present disclosure now will be described more fully hereinafter with reference to the accompanying drawings, which form a part hereof, and which show, by way of illustration, specific exemplary embodiments by which the disclosure may be practiced. This disclosure may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present disclosure may be embodied as methods or devices. Accordingly, the present disclosure may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, although it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and includes plural references.

As used herein, the term “fillers” may include any compound or composition that may be used to vary the density and other properties of the subject golf ball core and/or cover. Fillers useful in the golf ball core according to the present disclosure may include, for example, metal (or metal alloy) powders, metal oxide, metal stearates, particulate, carbonaceous materials, and the like or blends thereof. The amount and type of fillers utilized may be governed by the amount and weight of other ingredients in the composition, since a maximum golf ball weight of 1.620 ounces (45.92 gm) has been established by the United States Golf Association (USGA).

Examples of useful metal (or metal alloy) powders may include, but are not limited to, bismuth powder, boron powder, brass powder, bronze powder, cobalt powder, copper powder, inconel metal powder, iron metal powder, molybdenum powder, nickel powder, stainless steel powder, titanium metal powder, zirconium oxide powder, aluminum flakes, tungsten metal powder, beryllium metal powder, zinc metal powder, or tin metal powder. Examples of metal oxides may include but are not limited to zinc oxide, iron oxide, aluminum oxide, titanium dioxide, magnesium oxide, zirconium oxide, and tungsten trioxide. Examples of particulate carbonaceous materials may include but are not limited to graphite and carbon black. Examples of other useful fillers may include but are not limited to graphite fibers, precipitated hydrated silica, clay, talc, glass fibers, aramid fibers, mica, calcium metasilicate, barium sulfate, zinc sulfide, silicates, diatomaceous earth, calcium carbonate, magnesium carbonate, regrind (which may be recycled uncured polymeric material mixed and ground to 30 mesh particle size), manganese powder, and magnesium powder.

In particular embodiments, the change in cover material may be reversible. In another embodiment, the change may be reversible by SMPs. Specifically, SMPs may be capable of changing from a first configuration to a second configuration, and back again, upon application of an external stimulus.

SMPs may be a class of smart materials which are able to “memorize” a permanent shape.

SMPs may be fixed to temporary shapes under appropriate conditions, and also recover to permanent shapes in response to an external trigger, e.g. heat, light, moisture, or magnetism.

Compared with their alloy counterparts, shape memory alloys, SMPs exhibit many advantages, including low density, extremely high recoverable strain, broad shape recovery temperature range, and a variety of different methods of external stimulation to undergo reversible transformations.

The SMPs of the present disclosure may be used in any layer of a golf ball.

These SMPs may be an improvement to the golf ball layer due to their fast recovery from deformation and the ability to rebound their initial shapes without losing their properties.

SMPs may recover faster from abrasion on the surface of a golf ball at impact.

Shape memory polyurethanes may be used as a TPU or cast urethane in the outermost layer of a golf ball.

In another embodiment, the disclosure describes golf equipment which may include one or more SMPs added to a layer.

In another embodiment, the disclosure describes golf equipment which may include one or more SMPs added to a layer, wherein the layer may be the outermost layer, coating, or cover.

In another embodiment, the disclosure describes golf equipment which may include one or more SMPs added to a layer, wherein the golf equipment may be one or more golf balls.

In another embodiment, the disclosure describes golf equipment which may include one or more SMPs added to a layer, wherein one or more of the SMPs may be cast in the golf equipment.

In another embodiment, the disclosure describes golf equipment which may include one or more SMPs added to a layer, wherein one or more of the SMPs may be cast in the golf equipment, and wherein the golf equipment may be one of more golf balls.

In another embodiment, the disclosure describes golf equipment which may include one or more SMPs added to a layer, wherein one or more of the SMPs may be molded in the golf equipment.

In another embodiment, the disclosure describes golf equipment which may include one or more SMPs added to a layer, wherein one or more of the SMPs may be molded in the golf equipment, and wherein the golf equipment may be one of more golf balls.

In another embodiment, the disclosure describes golf equipment which may include one or more SMPs added to a layer, wherein one or more of the SMPs may include: a polyurethane; a polysulfone; a polyester; a polyamide; and a polyimide.

In another embodiment, the disclosure describes golf equipment which may include one or more SMPs added to a layer, wherein one or more of the SMPs may be a polyurethane.

In another embodiment, the disclosure describes golf equipment which may include one or more SMPs added to a layer, wherein one or more of the SMPs may be an adamantane-containing polyurethane.

In another embodiment, the disclosure describes golf equipment which may include one or more SMPs added to a layer, wherein one or more of the SMPs may be an adamantane-containing polyurethane, and wherein the adamantine-containing polyurethane may be synthesized by the chemical composition which may include: 1,3-adamantanediol; hexamethylene diisocyanate; and 1,4-butanediol.

In another embodiment, the disclosure describes golf equipment which may include one or more SMPs added to a layer, wherein one or more of the SMPs may be an adamantane-containing polyurethane, and wherein the adamantine-containing polyurethane may be synthesized by chemicals with the following ranges (about) of chemical compositions: 0-10 mmol 1,3-adamantanediol; 0-10 mmol hexamethylene diisocyanate; 0-10 mmol 1,4-butanediol.

In another embodiment, the disclosure describes golf equipment which may include one or more SMPs added to a layer, wherein one or more of the SMPs may be used in the golf ball core formulation.

In another embodiment, the disclosure describes golf equipment which may include one or more SMPs added to a layer, wherein one or more of the SMPs may be used in the golf ball core formulation, and wherein one or more of the SMPs used in the golf ball core formulation may be used in combination with rubber.

In another embodiment, the disclosure describes golf equipment which may include one or more SMPs added to a layer, wherein one or more of the SMPs may be used in the golf ball core formulation, and wherein one or more of the SMPs used in the golf ball core formulation may be used in combination with a high acid ionomer.

Suitable SMPs may include, but are not limited to, thermoplastic urethanes and polyethylene methacrylic acid resins commercially available as Nucrel® from DuPont. Additional suitable thermoplastics may include copolymers of ethylene and methacrylic acid having an acid level from about 3% to about 25% by weight. The acid level ranges from about 4% to about 15%, and possibly from about 7% to about 11%. Copolymers of ethylene and methacrylic acid may have an advantage in that these compounds typically have high melt flow index. Other suitable thermoplastics may include copolymers of ethylene and a carboxylic acid, or terpolymers of ethylene, a softening acrylate class ester such as methyl acrylate, n-butyl-acrylate or iso-butyl-acrylate, and a carboxylic acid. Exemplary carboxylic acids may be acrylic acid, methacrylic acid or maleic acid. Exemplary softening acrylate class esters may be methyl acrylate, n-butyl-acrylate or iso-butyl-acrylate. Examples of such terpolymers may be include polyethylene-methacrylic acid-n or iso-butyl acrylate and polyethylene-acrylic acid-methyl acrylate, polyethylene ethyl or methyl acrylate, polyethylene vinyl acetate, polyethylene glycidyl alkyl acrylates. Other suitable low flexural modulus thermoplastics may include “very low modulus acid copolymer ionomer” or VLMI, wherein the copolymer may contain about 10% by weight of acid and 10-90% of the acid may be neutralized by sodium, zinc or lithium ions. The VLMI may have flexural modulus of about 2,000 to 8,000 psi. Suitable VLMIs may include Surlyn® 8320 (Na), Surlyn® 9320(Zn) and Surlyn® 8120(Na). These high acid copolymer ionomers and VLMIs are described in U.S. Pat. No. 6,197,884.

Suitable composite materials may include a matrix material and a filament material embedded in the matrix material. The matrix material may be molded about the filament material so that the filament material may be embedded in the matrix material. In this embodiment, the matrix material may be a thermoset or a thermoplastic polymer. Suitable thermoset polymeric materials may include, but are not limited to, unsaturated polyester resins, vinyl esters, epoxy resins, phenolic resins, polyurethanes, polyurea, polyimide resins, and polybutadiene resins. Suitable thermoplastics include, but are not limited to, polyethylene, polystyrene, polypropylene, thermoplastic polyesters, acrylonitrile butadiene styrene (ABS), acetal, polyamides including semicrystalline polyamide, polycarbonate (PC), shape memory polymers, polyvinyl chloride (PVC), polyurethane, trans-polybutadiene, liquid crystalline polymers, polyether ketone (PEEK), bio(maleimide), and polysulfone resins. The matrix material may also be a silicone material, such as a silicone polymer, a silicone elastomer, a silicone rubber, silicone resins, or a low molecular weight silicone fluid, thermoplastic silicone urethane copolymers and variations, and the likes. Silicone polymers include silicone homopolymers, silicone random copolymers, and silicone-organic (block) copolymers. Silicone elastomers are defined as high-molecular-weight linear polymers, usually polydimethysiloxanes. Silicone rubbers may include commercially available gums, filler-reinforced gums, dispersions, and uncatalyzed and catalyzed compounds. Silicone resins contain Si atoms with no or only one organic substituent; they are therefore crosslinkable to harder and stiffer compounds than the elastomers. Low molecular weight silicone fluids may include oligomers. Silicone materials are further disclosed, for example, in U.S. Pat. Nos. 6,162,134 and 6,159,110, the entire disclosures of which are hereby incorporated herein by reference. The matrix may also be formed of ionomers including highly neutralized polymers, or blends thereof with one or more of the above matrix materials. The specific formulations of these materials may include additives, fillers, inhibitors, catalysts and accelerators, and cure systems depending on the desired performance characteristics. The matrix material may be at least one polymer or a blend of polymers.

The foregoing description and drawings merely explain and illustrate the invention and the invention is not limited thereto. While the specification is described in relation to certain implementation or embodiments, many details are set forth for the purpose of illustration. Thus, the foregoing merely illustrates the principles of the invention. For example, the invention may have other specific forms without departing from its spirit or essential characteristic. The described arrangements are illustrative and not restrictive. To those skilled in the art, the invention is susceptible to additional implementations or embodiments and certain of these details described in this application may be varied considerably without departing from the basic principles of the invention. It will thus be appreciated that those skilled in the art will be able to devise various arrangements which, although not explicitly described or shown herein, embody the principles of the invention and, thus, within its scope and spirit.

What is claimed is:

1. A golf ball comprising:
one or more layers including one or more shape memory polymers (SMPs),
wherein at least one of the one or more layers is an outer layer, and
wherein the one or more SMPs comprise at least one of:
a. a polyurethane;
b. a polysulfone;
c. a polyester;
d. a polyamide; or
e. a polyimide.

2. The golf ball of claim 1, wherein at least one of the one or more SMPs is cast in the golf ball.

3. The golf ball of claim 1, wherein at least one of the one or more SMPs is molded in the golf ball.

4. The golf ball of claim 1, wherein the one or more SMPs are a polyurethane.

5. The golf ball of claim 1, wherein the one or more SMPs are an adamantane-containing polyurethane.

6. The golf ball of claim 5, wherein the adamantine-containing polyurethane is synthesized by a chemical composition comprising:
1,3-adamantanediol;
hexamethylene diisocyanate; and
1,4-butanediol.

7. The golf ball of claim 5, wherein the adamantine-containing polyurethane is synthesized by a chemical with a chemical composition:
about 0-10 mmol 1,3-adamantanediol;
about 0-10 mmol hexamethylene diisocyanate;
about 0-10 mmol 1,4-butanediol.

8. The golf ball of claim 1 further comprising a golf ball core, wherein the golf ball core includes the one or more SMPs.

9. The golf ball of claim 8, wherein the golf ball core further includes rubber.

10. The golf ball of claim 8, wherein the golf ball core further includes a high acid ionomer.

11. Golf equipment comprising:
one or more layers including one or more shape memory polymers (SMPs),
wherein at least one layer of the one or more layers is an outer layer, and
wherein at least one of the one or more SMPs comprises at least one of:
a polyurethane;
a polysulfone;
a polyester;
a polyamide; or
a polyimide.

12. The golf equipment of claim 11, wherein at least one of the one or more SMPs is cast in the golf equipment.

13. The golf equipment of claim 11, wherein at least one of the one or more SMPs is molded in the golf equipment.

14. The golf equipment of claim 11, wherein the one or more SMPs are a polyurethane.

15. The golf equipment of claim 11, wherein the one or more SMPs are an adamantane-containing polyurethane.

16. The golf equipment of claim 15, wherein the adamantine-containing polyurethane is synthesized by a chemical composition comprising:
1,3-adamantanediol;
hexamethylene diisocyanate; and
1,4-butanediol.

17. The golf equipment of claim 15, wherein the adamantine-containing polyurethane is synthesized a chemical with a chemical composition:
about 0-10 mmol 1,3-adamantanediol;
about 0-10 mmol hexamethylene diisocyanate;
about 0-10 mmol 1,4-butanediol.

18. A golf ball comprising:
a golf ball core; and
an outer layer including one or more shape memory polymers (SMPs),
wherein the one or more shape memory polymers includes at least one of:
a polyurethane;
a polysulfone;
a polyester;
a polyamide; or
a polyimide.

19. The golf ball of claim 18, wherein the one or more SMPs are a polyurethane.

20. The golf ball of claim 18, wherein the one or more SMPs are an adamantane-containing polyurethane.
